(19) United States
(12) Patent Application Publication
(10) Pub. No.: US 2014/0144549 A1
(43) Pub. Date: May 29, 2014

(54) Drill Bit Pencil Sharpener

(71) Applicant: David Kenneth Watson, Valley Center, CA (US)

(72) Inventor: David Kenneth Watson, Valley Center, CA (US)

(21) Appl. No.: 13/685,717

(22) Filed: Nov. 27, 2012

(51) Int. Cl. B43L 23/00

(52) U.S. Cl. CPC B43L 23/008; B43L 23/00
USPC 144/365; 144/28.6; 144/28.71; 144/28.72

(57) ABSTRACT

A pencil sharpener powered by a drill and a method of use are disclosed herein. The pencil sharpener is configured with a cutting mechanism to sharpen a non-circular carpenter pencil. The pencil sharpener has a housing body to receive pencil shavings from the pencil. The housing body has a slotted hole configured to receive the carpenter pencil and prevent excessive rotation of the pencil.

### FIELD OF THE INVENTION

The present invention relates generally to drill bits, drills and pencil sharpeners. More specifically, the present invention relates to drill bits and attachments configured to sharpen pencils or other writing instruments.

### BACKGROUND OF THE INVENTION

Drill bits are well known in the art and are typically used to mechanically drill a hole into a material. Other drill bits may have screwdriver tips to facilitate use of the drill as an electric screwdriver. Pencil sharpeners are also well known in the art. Two common varieties of pencil sharpeners are the prism sharpener and the planetary sharpener. Pencil sharpeners can be manually driven, mechanical or electric. A manual prism sharpener is a small razor blade that essentially shaves the wood off of the pencil. A planetary sharpener generally comprises a cylindrical cutter resembling a spiral of blades to rotate around the pencil by way of a crank and planetary gears. The planetary sharpener has been modified over the years to incorporate a small motor instead of a crank to move the cylindrical cutter.

Pencils that are shaped in a generally rectangular or elliptical shape are known in the art as carpenter pencils. Carpenter pencils are traditionally sharpened by hand with a knife because the shape of the carpenter pencils does not facilitate easy sharpening by mechanical means. Known pencil sharpeners generally have circular holes which are not sized properly for accepting carpenter pencils. If the holes are too small, the carpenter pencil will not be able to enter the sharpener. If the holes are too big, the carpenter pencil will needlessly rotate along the rotational axis of the sharpener.

Manual prism sharpeners for carpenter pencils are known in the art and are a viable alternative to using a razor blade to sharpening a pencil. However, a manual sharpener still requires time and physical effort to sharpen the carpenter pencil. A mechanically operated sharpener would solve the deficiencies in the art of pencil sharpeners.

There is a need in the art for a pencil sharpener for carpenter pencils that are mechanically operated by an electrically powered motor such as a drill. The present invention aims to solve this deficiency in the art.

### SUMMARY OF THE INVENTION

The present invention is directed to a pencil sharpener configured to sharpen a pencil, wherein the pencil sharpener has a shaft, a cutting mechanism and a housing body. The pencil may be generally circular or hexagonal in shape. The pencil may also be a non-circular shape such as rectangular or elliptical. The shaft is used with a drill by inserting the shaft into the drill's chuck allowing the drill to rotate the shaft. The cutting mechanism has a plurality of cutting barrels to shave the pencil resulting in pencil shavings removed from the pencil. The pencil shavings are received by the housing body which generally encapsulates the cutting mechanism.

The housing body has a cap along a bottom side which is removable to allow for extraction of the pencil shavings. Also featured on the housing body is a slotted hole configured to receive the pencil. A sliding adapter is near the slotted hole and has a circular hole therein. The circular hole can be removably positioned over the slotted hole to provide physical guidance to the pencil when entering the slotted hole.

The present invention is also directed to a method for sharpening a pencil, including carpenter pencils which are of noncircular sizes. The method has the steps of: providing a housing body configured to receive pencil shavings; providing a cutting mechanism enclosed in the housing body and attached to a shaft; inserting the shaft into a drill; inserting the pencil into the cutting mechanism; and activating the drill to rotate the shaft. The rotation of the shaft in turn rotates the cutting mechanism around the pencil to cut shavings off of the pencil.

In another aspect of the present invention, a pencil sharpener is disclosed having a housing body without a drill shaft. An electric battery and a motor is coupled to the pencil sharpener to provide energy to operate a cutting mechanism within the pencil sharpener housing body. The electric battery is removable from the pencil sharpener to allow for replenishing stored electricity. The pencil sharpener and the housing body may also be integral to a drill body to provide a new power tool dedicated to sharpening a pencil. The drill body has a trigger, a grip and an electric battery. The trigger is configured to operate the cutting mechanism in the pencil sharpener when it is depressed.

It is an object of the present invention to provide a pencil sharpener configured to receive non-circular pencils, known as carpenter pencils. It is a further object of the present invention to provide a pencil sharpener operated by a drill. Yet another object of the present invention is having a standalone pencil sharpener to sharpen non-circular pencils.

While the apparatus and related method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a pencil sharpener attached to a drill configured to sharpen a round pencil or a carpenter's pencil.

FIG. 2 is a side view of the pencil sharpener.

FIG. 3 is a front view of the pencil sharpener having a slotted hole and a slide-over adapter having a rounded hole.

FIG. 4 is a rear view of the pencil sharpener.

FIG. 5 is a cross-sectional view of the pencil sharpener featuring an inner cavity and a cutting mechanism.

FIG. 6 is a side view an alternative embodiment of a pencil sharpener.

FIG. 7 is a front view of the pencil sharpener of FIG. 6 having a slotted hole and a slide-over adapter having a rounded hole.

FIG. 8 is a perspective view of the pencil sharpener of FIG. 6.

FIG. 9 is a front view of another alternative embodiment of a pencil sharpener having an integral drill body.

FIG. 10 is a side view of the pencil sharpener of FIG. 9.

FIG. 11 is a perspective view of the pencil sharpener of FIG. 9 configured to sharpen a round pencil or a carpenter's pencil.

### DETAILED DESCRIPTION OF THE PREFERRED EMBODIMENTS

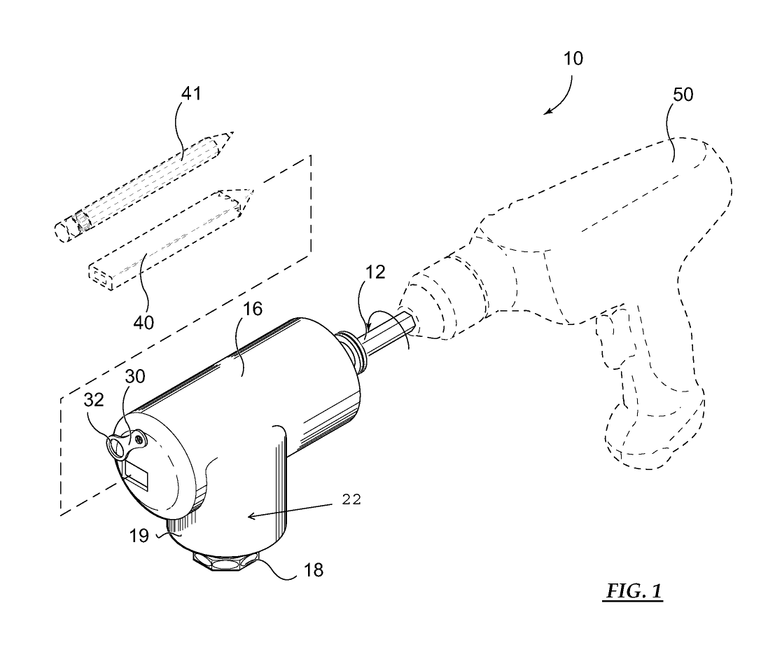

With reference to the drawings, FIG. 1 is a perspective view of a pencil sharpener 10 attached to a drill 50. The pencil sharpener 10 has a drill shaft 12, a cutting mechanism 14, and a housing body 16. A user may insert a carpenter pencil 40 or a round pencil 41 into the pencil receiver 13. The drill shaft 12 is typically an integral part of the pencil sharpener. Alternately, the drill shaft 12 is inserted into the drill 50 at a rear drill hole 11 to allow the drill 50 to rotate the drill shaft 12. The drill shaft 12 is preferably of universal construction to allow placement in a variety of drills 50 from different manufacturers. The universal approach to the drill shaft 12 allows the drill 50 to be of any functional design such as electric or pneumatic drills, and also allows it to accommodate drills from various manufacturers. It is conceivable that embodiments of the present invention could incorporate a shaft 12 as part of the pencil sharpener 10 or that a drill and shaft attachment could be inserted into a female drill hole 11 to effectuate the sharpening action.

The housing body 16 is preferably a general ‘T’ shape to provide an inner cavity 17 and a lower portion 19 to receive pencil shavings removed from the carpenter pencil 40 or the round pencil 41. In a preferred embodiment, the housing body 16 generally cylindrical with a 2″ diameter and 4″ in length. The lower portion 19 preferably extends 1″ to 2″ below the housing body 16 to extend the inner cavity 17 to accommodate the base opening 22 and the cap 18 without getting caught or jammed into the cutting mechanism 14. An alternative embodiment may forgo the lower portion 19 and have the base opening 22 and the cap 18 positioned in a location that would not affect operation of the cutting mechanism 14.

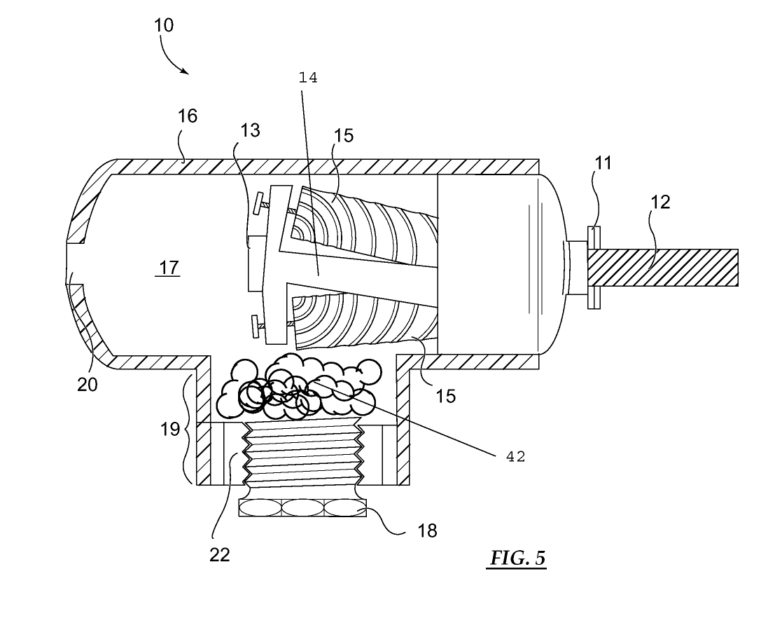

As can be seen in FIG. 5, the housing body 16 allows the user to use the pencil sharpener 10 without coming into contact with moving parts such as the drill shaft 12 or the cutting mechanism 14. The housing body 16 is also generally enclosed to capture substantially all of the pencil shavings 42 within the inner cavity 17 to keep the work area clean of the pencil shavings 42. The lower portion 19 has a base opening 22 and a cap 18. The base opening 22 and the cap 18 are complementarily coupled to enclose the lower portion 19 of the housing body 16. The cap 18 and the base opening 22 are preferably threaded to allow the cap 18 to be rotationally screwed into a locked position. Alternatively, the cap 18 can be frictionally or magnetically coupled to the base opening 22 to achieve a similar seal to keep the housing body 16 closed at the lower portion 19. When the pencil shavings 42 need to be removed from the inner cavity 17, the cap 18 is removed to allow the user to empty the inner cavity 17. After removal of the pencil shavings 42, the cap 18 is easily placed back into the base opening 22.

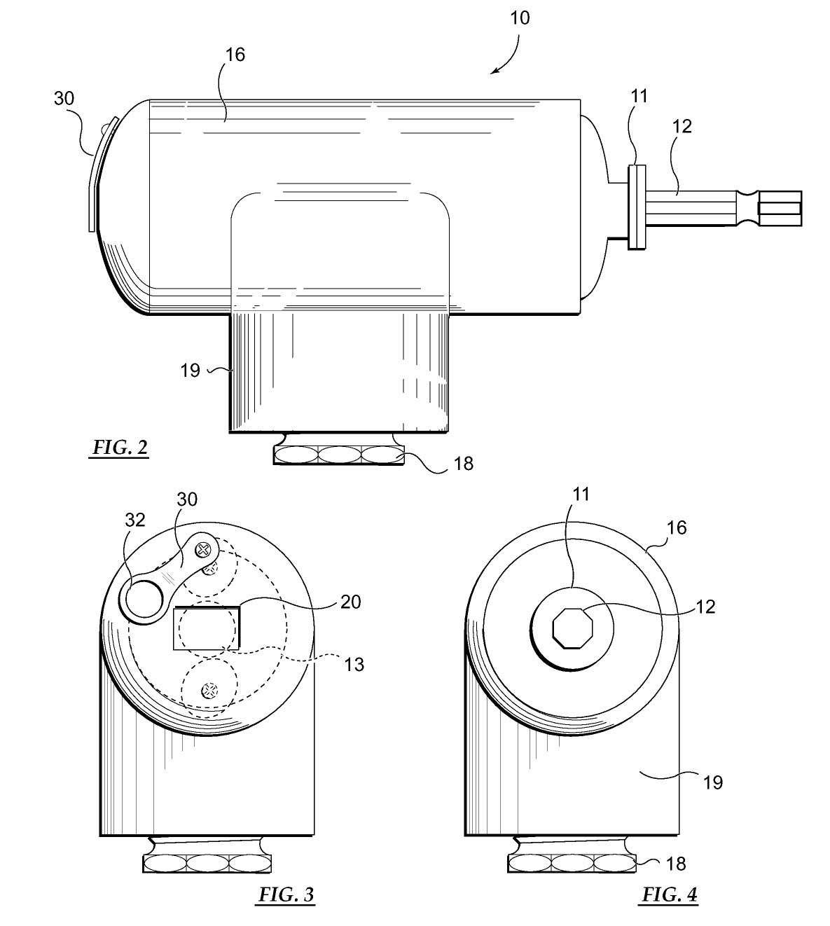

With regard to FIG. 3, a front view of the housing body 16 is shown. The housing body 16 has a slotted hole 20 preferably shaped to resemble a rectangle. The slotted hole 20 is configured to receive the pencil 40. The slotted hole 20 allows for the pencil 40 to be inserted into the housing body 16 to reach the pencil receiver 13 of the cutting mechanism 14. The rectangular shape of the slotted hole 20 is designed to properly accommodate the pencil 40 in the event it is generally rectangular or elliptical in a cross-sectional view and known in the art as a carpenter pencil. In a preferred embodiment, the slotted hole 20 is ⅜″×⅝″ to accommodate the pencil 40.

The housing body 16 further has a slide-over adapter 30 (See FIGS. 1,2). The slide-over adapter 30 has a circular hole 32 removably positionable over the slotted hole 20 (FIG. 3). The circular hole 32 allows the pencil 40 which may alternatively be round in a cross-sectional view to be inserted into the housing body 16 to be sharpened by the cutting mechanism 14. In a preferred embodiment, the circular hole 32 has a ⅜″ diameter. The slide-over adapter 30 is pivotable in pendulum fashion over the slotted hole 20. Alternatively, the slide-over adapter 30 may be slid into place laterally. Both the slotted hole 20 and the circular hole 32 are configured to maintain proper positioning of the pencil 40 depending on the shape of the pencil 40.

FIG. 4 illustrates a rear view of the pencil sharpener 10. The shaft 12 is preferably centered on the housing body 16 for optimal balance and control. This allows the shaft 12 and the pencil 40 to line up without causing an imbalance of forces applied to the pencil sharpener 10.

With respect to FIG. 5, a cross-sectional view of the pencil sharpener 10 is illustrated. In a preferred embodiment, the cutting mechanism 14 has a pencil receiver 13 and a plurality of cutting barrels 15. The plurality of cutting barrels 15 are angled relatively to each other to achieve the desired sharpness by cutting at the pencil 40 or 41 to create pencil shavings 42. In a preferred embodiment, the cutting mechanism 14 is indirectly coupled to the drill shaft 12 to facilitate a rotational movement of the plurality of cutting barrels 15 similar to that of known planetary pencil sharpeners. In another embodiment, one cutting barrel could possibly be used.

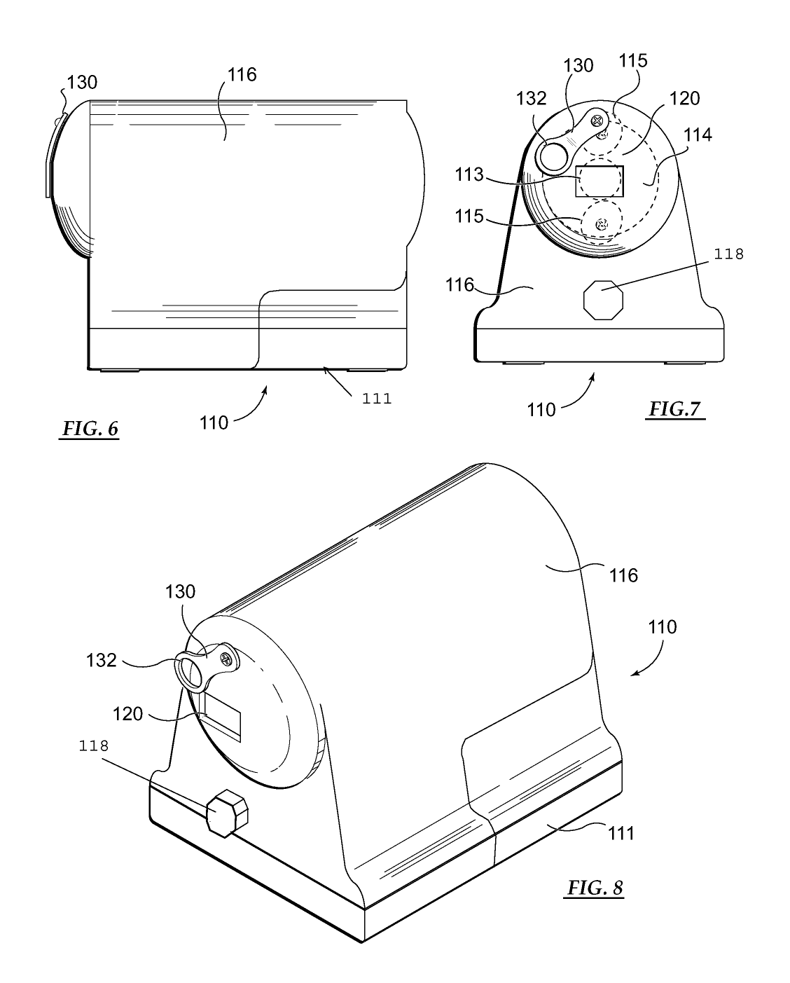

An alternative embodiment of the present invention is illustrated in FIGS. 6-8. Illustrated is a pencil sharpener 110 that does not feature a drill shaft 12 to provide the mechanical energy to operate a cutting mechanism 114 having a pencil receiver 113 and a plurality of cutting barrels 115. Rather, the pencil sharpener 110 is powered by a rechargeable battery 111 that slides into the unit. The electric power source 111 operates a motor to rotate the cutting mechanism 114 similar to that of the drill shaft 12 in the preferred embodiment of the pencil sharpener 10 described above. Preferably, the electric power source 111 is a rechargeable battery to allow the pencil sharpener 110 to stand freely without wires. As shown in FIG. 7, the pencil sharpener 110 has a housing body 116 with a slotted hole 120 for insertion of a non-circular pencil 41. Similarly, the housing body 116 features a slide-over adapter 130 with a circular hole 132 configured to be positioned over the slotted hole 120. Also, in embodiments shown in FIGS. 7 and 8, a threaded cap is depicted for pencil shaving removal. Also depicted in FIGS. 7-8 is a cap 118 that may be removed to allow the user to empty pencil shavings from the inner housing body 116.

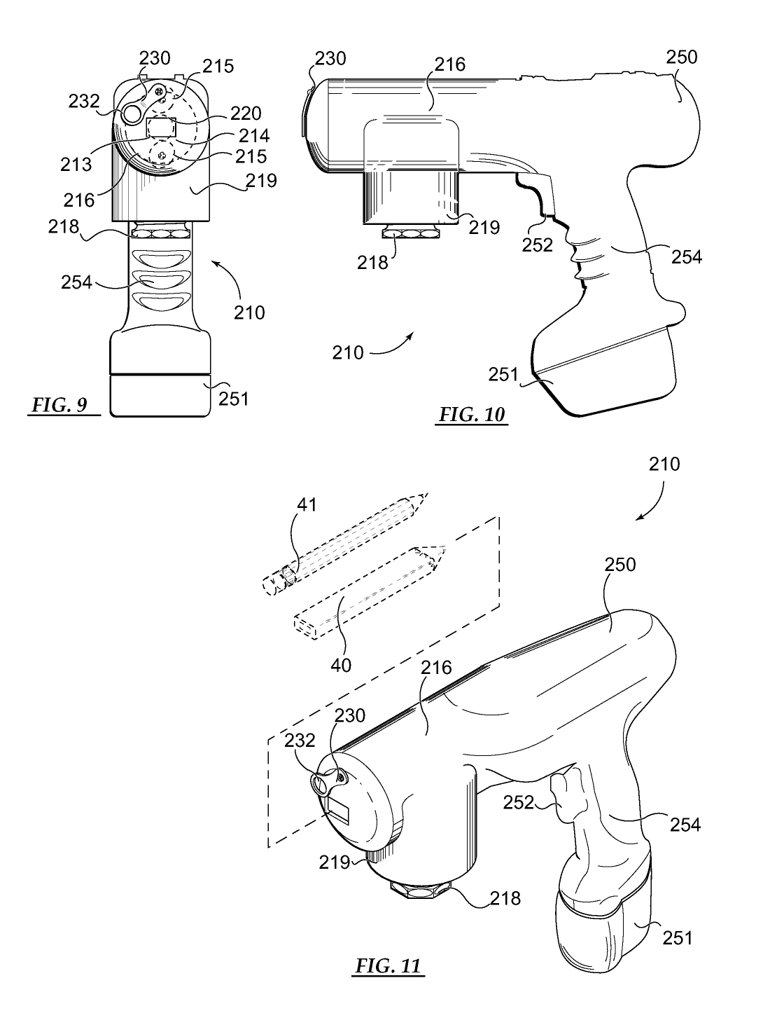

FIGS. 9-11 illustrate another alternative embodiment of a pencil sharpener 210 wherein the pencil sharpener 210 has a housing body 216 and is integral to a drill body 250. The housing body 216 may have a lower portion 219 and a cap 218 for the capture and removal of pencil shavings. The pencil sharpener 210 sharpens a pencil 40 or 41 with a cutting mechanism 214 having a pencil receiver 213 and a plurality of cutting barrels 215. In yet another embodiment, the housing body 216 may be configured so that it is releasably attachable at the users option to commercially available power drills, and so that the housing envelops the front portion of the drill. In this manner, a person on a job site who needs to sharpen a pencil, of any size or shape, can simply attach the pencil sharpener housing body 216 to an existing drill, lock it in place and pull the drill trigger, whereby the pencil is sharpened by the internal cutting mechanism 214. This will improve the ease and time required to sharpen pencils on the jobsite.

Referring to FIG. 10, the drill body 250 features an electric battery 251, a trigger 252 and a grip 254. The trigger 252 is configured to operate the cutting mechanism 214 when pressed by providing power from the electric, and preferably rechargeable battery 251 to operate a motor. This embodiment also allows the pencil sharpener 210 to operate without the drill shaft 12 for improved stability when sharpening a pencil 40 or 41. The grip 254 may optionally have ribbing to ensure a proper hold on the drill body 250.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

While the particular Combination Storage, Dispensing and Feeding Device as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

I claim:

1. A pencil sharpener to sharpen pencils of variable sizes, comprising:
a shaft that is rotatable;
a cutting mechanism fixedly attached to the shaft and that is rotatable with the shaft wherein the cutting mechanism is configured to receive a pencil; and
a housing body, wherein the housing body is configured to receive pencil shavings from the pencil.

2. The pencil sharpener of claim 1, wherein a shaft is operably configured to be inserted into a chuck of a drill to allow the drill to rotate the shaft.

3. The pencil sharpener of claim 1, operably configure to be fixed to a power drill used to drive the cutting mechanism.

4. The pencil sharpener of claim 1, wherein the cutting mechanism comprises a plurality of cutting barrels configured to shave the pencil to produce the pencil shavings, whereby the pencils are sharpened.

5. The pencil sharpener of claim 1, wherein the housing body defines a T-shape with a low portion, and where the housing is enclosed to receive substantially all of the pencil shavings.

6. The pencil sharpener of claim 1, wherein the housing body further comprises a cap configured to be removable from the housing body to extract the pencil shavings from the housing body at said low portion of the housing.

7. The pencil sharpener of claim 1, wherein the pencil has a body that is generally non-circular.

8. The pencil sharpener of claim 1, wherein the housing body further comprises a slotted hole configured to receive the pencil.

9. The pencil sharpener of claim 8, further comprising a sliding adapter comprising a circular hole, wherein the circular hole is removably positioned over the slotted hole to receive a round pencil.

10. A method for sharpening a pencil of variable sizes, comprising the steps of:
providing a housing body configured to receive pencil shavings;
providing a cutting mechanism in the housing body, wherein the cutting mechanism is enclosed by the housing body, wherein the cutting mechanism is attachable to a shaft;
inserting the shaft into a drill;
inserting the pencil into the cutting mechanism; and
activating the drill to rotate the shaft, whereby the cutting mechanism is rotated to sharpen the pencil.

11. The method for sharpening a pencil of claim 10, wherein the housing body further comprises a cap that is configured to be removable from the housing body to extract the pencil shavings from the hollow body.

12. The method for sharpening a pencil of claim 10, wherein the housing body further comprises a slotted hole configured to receive the pencil.

13. The method for sharpening a pencil of claim 12, wherein the housing body further comprises a sliding adapter comprising a circular hole, wherein the circular hole is removably positioned over the slotted hole to receive the pencil.

14. A pencil sharpener, comprising:
a cutting mechanism configured for shaving a pencil;
said cutting mechanism being fixedly attachable to a shaft that is rotatable, and wherein said power for rotating said shaft is provided by a power drill;
a housing body configured for containing the cutting mechanism and shaft and further comprising a slotted hole configured to receive a substantially non-circular pencils.

15. The pencil sharpener of claim 14, further comprising an battery to mechanically operate the cutting mechanism.

16. The pencil sharpener of claim 15, wherein said battery is rechargeable.

17. The pencil sharpener of claim 14, wherein a housing is configured to attach directly to a drill body .

18. The pencil sharpener of claim 14, wherein a housing with a cutting mechanism is integral to the drill.

19. The pencil sharpener of claim 14 wherein a housing with a cutting mechanism is removably attachable to the drill of a user.

20. The pencil sharpener of claim 14 further comprising a slide over adapter to augment the pencil shape that may be accommodated and sharpened by the sharpener.
